(19) United States
(12) Patent Application Publication
(10) Pub. No.: US 2023/0345974 A1
(43) Pub. Date: Nov. 2, 2023

(54) JUICE FILTRATION SYSTEM AND METHODS

(71) Applicant: THE COCA-COLA COMPANY, Atlanta, GA (US)

(72) Inventors: Alonso GARCIA DE BLANES, Windmere, FL (US); Nicholas MCCARTY, Kennesaw, GA (US); Jose Sosa GARCIA YEVENES, Atlanta, GA (US)

(73) Assignee: THE COCA-COLA COMPANY, Atlanta, GA (US)

(21) Appl. No.: 17/800,668

(22) PCT Filed: Feb. 17, 2021
(86) PCT No.: PCT/US2021/018363

§ 371 Date: Aug. 18, 2022

Related U.S. Application Data
(60) Provisional application No. 62/978,013, filed on Feb. 18, 2020.

(51) Int. Cl. A23L 2/74; A23L 2/02; B01D 61/14; B01D 61/02; B01D 61/58; B01D 61/04; B01D 69/02; B01D 61/18; B01D 61/08

(52) U.S. Cl. CPC A23L 2/74; A23L 2/02; B01D 61/147; B01D 61/027; B01D 61/58; B01D 61/04; B01D 69/02; B01D 61/18; B01D 61/08; B01D 2311/04; B01D 2311/06; B01D 2325/02834; B01D 2325/20

(57) ABSTRACT

The present disclosure provides a juice filtration system to effectively reduce calorie and sugar contents, reduce bitterness, and improve the overall flavor of a juice. A method for making a fruit beverage utilizing the juice filtration system is also provided. The method includes multi-step filtrations of feed juice(s) followed by selective combination of the intermediate products, by-products, the feed juice(s), and/or other fruit source(s) to form the fruit beverage. A fruit beverage having a 100% identity to the original fruit source(s), reduced calorie and sugar content, reduced bitterness, enhanced vitamin nutrition, and improved flavor, free from external ingredients is provided.

This application is being filed on Feb. 17, 2021, as a PCT International Patent application and claims the benefit of priority to U.S. Provisional patent application Ser. No. 62/978,013, filed Feb. 18, 2020, the entire disclosure of which is incorporated by reference in its entirety.

### INTRODUCTION

Consumable fruit beverages, juices, or fruit juices are widely used in food industry because of their excellent sources of nutritional and beneficial values. However, there has been a considerable: decline in juice consumption recently due in part to its calorie and sugar content. Awareness of healthy diets and the risks of obesity and diabetes in global countries are moving consumers towards low calorie, low sugar beverages. Today's low calorie juice beverages are primarily diluted juices with water, and include artificial flavoring, and/or ingredients from external sources. Such diluted juices lack a “natural flavor” and do not contain the nutritional benefits of the original whole juices. Moreover, low calorie beverage products with zero or reduced sweetness are much less appealing to consumers.

There is also an increasing demand for better flavor or palatability of beverage products. Materials containing bitterness-inducing or bitter substances in a juice or a fruit beverage have reduced palatability because they are bitter. Furthermore, beverages containing external ingredients such as artificial sweeteners and the like have both a bitterness and an off-after-taste which render these less desirable. In addition, a beverage product also loses the strength of “natural flavor” if it is substantially de-bittered, leaving little-to-no bitter substances therein, it is thus desirable to maintain the natural flavor in fruit beverages by balancing the content of bitter substances.

Fruits contain water-soluble vitamins such as vitamins C, B1, B2 niacin, B6, folate, B12, biotin, and pantothenic acid. Vitamins are generally considered beneficial to human health, but are usually not stable during the making and processing of fruits and beverage products, and are easily destroyed as a result of heating, compounding, exposure to air, storing, or other industrial conditions. It is highly desirable to increase the vitamin contents in fruit beverage products while reducing the sugar contents and maintaining other “natural” characteristics thereof, without bringing in external ingredients.

To satisfy consumer demand for unique and distinct taste profiles and/or appearances, it would also be desirable to provide economical fruit beverages by combining natural components from two or more distinct fruits, retaining the natural flavors of all originating fruits.

Methods for reducing calorie and sugars of fruit juices have been disclosed previously. For example, US 2008/0081096 to Subramaniam discloses a method and a processing system having multi-stage filters to reduce calories in a juice by selectively removing more sucrose than primary sugars, glucose and fructose.

US 2011/0165310 to Blasé discloses a method for treating a sugar-containing natural product for lowering its sugar content includes passing a stream of the natural product into contact with a bed of ionic material capable of chromatographically separating sugar from the natural product and chromatographically separating a sugar-diminished natural product from the adsorbent bed.

US 2012/0135124 to Letourneau discloses a juice beverage comprising at least one liquid derived from one or more fruits, one or more vegetables and combinations thereof, with identifiable tastes thereof.

US 2013/0251873 to Cetrulo discloses a method for making a beverage by combining a citrus juice source having a low Brix value, and thus a low sugar content, with added sinking pulp (or bottom pulp) and a sweetener which increases the perceived sweetness sensory characteristic of the juice beverage without significantly increasing the caloric content of the beverage.

U.S. Pat. No. 5,403,604 to Black disclosed a method to separate fruit juice sugars from fruit juice by a separation process that results in a high sugar content juice that has an increased Brix/acid (B/A) ratio and a low sugar content juice that has a decreased B/A ratio.

In spite of the above disclosures, it is still challenging to make fruit beverages meeting all the consumer needs stated herein in a single beverage product. The present disclosure provides a fruit beverage and the methods of producing a product that may include many or all of the aforementioned consumer needs in a single fruit beverage.

### Juice Filtration System and Methods

The present disclosure provides a juice filtration system to effectively reduce calorie and sugar contents, reduce bitterness, and improve the overall flavor of a juice. A method for making a fruit beverage utilizing the juice filtration system is also provided. The method includes multi-step filtrations of feed juice(s) followed by selective combination of the intermediate products, by-products, the feed juice(s), and/or other fruit source(s) to form the fruit beverage. A fruit beverage having a 100% identity to the original fruit source(s), reduced calorie and sugar content, reduced bitterness, enhanced vitamin nutrition, and improved favor, free, or substantially free, from external ingredients is provided.

In some embodiments, the present disclosure is related to a method of making a fruit beverage comprising: passing a feed juice of a first fruit having a first limonoid concentration through a first separation unit, whereby generating a first retentate and a first permeate passing the first permeate through a second separation unit, whereby generating a second retentate and a second permeate; and combining a portion of one or more components selected from the group consisting of: the feed juice of the first fruit, the first retentate, the second permeate, and the combinations thereof, whereby generating the fruit beverage, wherein the fruit beverage comprises one or more natural sugars including but not limited to sucrose, glucose, fructose, or combinations thereof, Vitamin C, and a limonoid, wherein the limonoid concentration is reduced by at least about 7% compared with the feed juice. In other embodiments, the limonoid concentration of the fruit beverage made according to the method is reduced by at least about 20%, at least about 30%, at least about 40%, at least about 50%, at least about 60%, at least about 70%, at least about 80%, at least about 90%, or at least about 99% compared with the feed juice.

In some embodiments, the method of making the fruit beverage further comprises adding a portion of a second fruit source during the combining step. In certain embodiments, the second fruit source is selected from a group consisting of orange pulp, not from concentrate (NFC) acerola puree, monk fruit juice, and combinations thereof.

In some embodiments, the fruit beverage made according to the method has a significantly lower Brix value and sugar contents compared with the feed juice. For example, the °Brix of the fruit beverage is reduced, compared with the feed juice, by about 30% to about 90%. In some embodiments, the concentration of total sugars of the fruit beverage is reduced, compared with the feed, juice, by about 30% to about 90%. In some embodiments, the concentration of sucrose of the fruit beverage is reduced, compared with the feed juice, by about 30% to about 90%. In some embodiments, the concentration of glucose of the fruit beverage is reduced, compared with the feed juice, by about 20% to about 80%. In some embodiments, the concentration of fructose of the fruit beverage is reduced, compared with the feed juice, by about 20% to about 80%.

In certain embodiments, the fruit beverage made according to the method has a Vitamin C concentration increased by about 0 to about 100%, compared with the feed juice.

In certain embodiments, the limonoid is a limonin, and the fruit beverage according to the method has a limonin concentration reduced by at least 7% compared with the feed juice.

In some embodiments, the present disclosure is related to a fruit juice filtration system comprising: a first separation unit for filtering a feed juice of at least one fruit to produce a first retentate and a first permeate; and a second separation unit for filtering the first retentate to produce a second retentate and a second permeate, wherein the second permeate has a Brix value that is reduced by at least about 20%, compared with the feed juice of the at least one fruit.

In some embodiments, the juice filtration system further comprises an operative unit for combining selected components to generate a fruit beverage product:

In some embodiments, the present disclosure relates to a fruit beverage comprising fruit solids, Vitamin C, one of more natural sugars including but not limited to sucrose, glucose, fructose, or the combinations thereof, a limonoid, wherein the fruit solids, the Vitamin C, the sugar, and the limonoid are all originated from at least one juice of at least one fruit, and wherein the fruit beverage is free or substantially free of external ingredients.

In some embodiments, the present disclosure is related to a fruit beverage made by the present fruit juice filtration process, wherein the fruit beverage consists essentially of the second permeate.

In other embodiments, the present disclosure is related to a fruit beverage made by a fruit juice filtration process, wherein the fruit beverage comprises a portion of a first retentate, wherein the first retentate is produced by passing a feed juice of a first fruit through a first separation unit, whereby a first permeate is also produced; and a portion of a second permeate, wherein the second permeate is produced by passing the first permeate through a second separation unit, whereby a second retentate is also produced, and wherein the fruit beverage comprises fruit solids, one or more natural sugars including but not limited to sucrose, glucose, fructose, or combinations thereof, Vitamin C, and limonoid, wherein the fruit solids, the Vitamin C, the sugar, and the limonoid are all originated from the feed juice of at least one fruit, and wherein the fruit beverage is free or substantially free of external ingredients.

In related embodiments, the fruit beverage made by the fruit filtration process further comprises a portion of a second fruit source, wherein the second fruit source is selected from a group consisting of orange pulp, acerola puree, monk fruit juice, and combinations thereof, wherein fruit beverage has a Brix value in a range from about 2° to about 10°, a Vitamin C concentration in a range from 20 mg/100 mL to 40 mg/100 mL, and a limonin concentration in a range from about 1.5 mg/L to about 3 mg/L.

Definitions and Interpretations of Terms

As used herein, “weight percent,” “wt %, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %, etc.

As used herein, “g” represents gram; “L” represents liter; “mg” represents “milligram (10⁻³ gram);” “mL” represents milliliter (10⁻³ liter); “nm” represents nanometer (10⁻⁹ meter); micrometer is 10⁻⁶ meter. The units “mg/100 g,” “mg/100 mL,” or “mg/L” are units of concentration or content of a component in a composition. One “mg/L” equals to one ppm (part per million). “Da” refers to Dalton, which is the unit for molecular weight; One Da equals to one g/mol. The unit of temperature used herein is degree Celsius ° C.).

The term “about” is used in conjunction with numeric values to include normal variations in measurements as expected by persons skilled in the art, and is understood have the same meaning as “approximately” and to cover a typical margin of error, such as +10% of the stated value. The term “about” Also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes haying two or more compounds that are either the same or different from each other. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2, 2-5; 2-4; 2-3; 3-5; 3-4; and 4-5.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

As used herein, a fruit juice refers to a composition having fluidic characteristics and comprising some or all components that are naturally present in the corresponding fruit(s). For example, orange juice, can be produced by squeezing and collecting the liquid from the orange. The resulting juice can be optionally subject to a centrifuge or other process to remove small pieces of orange peel and excess pulp and form a clear juice substantially free of insoluble contents.

A fruit juice can alternatively be cloudy and contain suspended fruit solids such as pulp. For example, an orange juice can contain a cloud suspension that contributes to the color, flavor, aroma, and turbidity of the orange juice. This cloud suspension comprises membranes, oil droplets, flavonoid crystals, chromatophores, and cell wall fragments of protein, pectin, cellulose, and hemicellulose. The components of juice cloud have varying particulate sizes that range from approximately 2 to 1000 microns. Particulates of larger size tend to settle in the juice over time. This material is commonly referred to as orange pulp. Smaller, colloidal particulates remain suspended in the juice and make up the stable cloud.

Juice concentrate is produced for example by passing the juice over a heat exchanger to remove most (about 80% to about 90%) of the native water. Juice concentrate is usually stored frozen until needed. Frozen concentrate is shipped domestically and internationally to local and regional beverage plants where it is reconstituted (adding back to the concentrate about equal amount of water that has been removed) to produce fruit juice or fruit juice beverages. The process of making juice concentration has a high-energy requirement and is therefore expensive. Frozen concentrate storage and shipment also incur considerable cost. More importantly, various nutritional ingredients can be lost during the process thereby causing the concentrate to loose healthy and economic value.

Fruit juice can also be sold as a single strength product and is typically labeled for the retail market as “not from concentrate” (NFC) juice. It is sold at a premium due to the higher quality, additional storage and transportation cost (single strength versus concentrate), and special (expensive) storage requirements.

A fruit beverage refers to as a consumable product derived from one or more fruits or fruit juices. During the making and preparation of fruit beverages, various intermediate products (or by-products) can be generated. For example, in a filtration process, a juice feed is filtered through a separation unit or stage, wherein, a retentate and a permeate can be produced simultaneously as intermediate products of the filtration. A retentate is the part of the feed that does not pass through the separation unit, while a permeate is that part of the feed that does pass through the separation unit. A retentate can comprise suspended solids and liquid of the juice. A permeate can be a clarified liquid of the juice, free or substantially free of visible solids. A fruit beverage can comprise one or more intermediate products.

Fruit juices and related products are typically characterized and regulated by the Brix value. Brix value is a refractive index scale for measuring the amount of total sugars (soluble sugar solids including but not limited to glucose, sucrose, and fructose) in a solution at a given temperature. One degree Brix (°Brix) is 1 gram of total sugars in 100 grams of solution and represents the strength of the solution as percentage by mass. Brix value can be measured using either a refractometer or a hydrometer. A refractometer determines °Brix by measuring the refraction of light passing through a liquid sample. Liquids containing sugar are denser than water and cause greater refraction as light passes through. The instrument compares this to the refraction of light through water and provides a Brix value. Alternatively, hydrometers calculate a liquid's sugar by measuring its relative density. Hydrometers typically utilize a weighted, floating glass tube that is placed inside a calibrated test tube containing the liquid sample. The test tube is calibrated to measure the amount of liquid displaced, and from that, determine how much sugar is present.

Limonoids are a class of natural phytochemicals of the triterpenoid class which abundant in citrus fruit. Limonoids contained in citrus fruit include limonin, nomilin, and nomilinic acid. Limonin is largely responsible for the bitterness of the fruit. Because of citrus greening disease (HLB), limonin levels of orange juice produced from Florida oranges are increasing while sugar content is decreasing. On the other hand, limonin also undoubtedly contributes to the “natural flavor” or “fruit taste.” Substantially de-tittered beverages do not taste like natural citrus fruits. Importantly, limonin is more recently found to be physiologically and medicinally beneficial. For example, citrus seed extracts having higher concentration of limonin are reported have antiviral properties, inhibiting replication of retroviruses HIV-1 and HTLV-I. Neuroprotective effects of limonin have also been found. Limonin is also reported to reduce proliferation of colon cancer cells and function as an anti-obesity agent in mice. Therefore, it is highly desirable to maintain a balanced content of limonin in fruit beverages for both improving the palatability, and preserving beneficial traits and the natural taste of fruits.

As noted herein, a fruit beverage is said to be a “whole juice,” or “100% juice,” or in a 100% identity to a whole juice or original fruit source only if it is free or substantially free of external ingredients unless the external ingredients are added for necessary purposes such as safety, regulation, etc. For example, a NFC juice is a 100% juice. External ingredients generally refer to materials that are not a part naturally present in the original fruit(s) where the fruit beverage is derived from. For example, artificial sweetener or food preservatives are an external ingredient. Natural ingredients that are not present in the original fruit(s) but obtained or processed biosynthetically from other sources are also external ingredients. Excess water added into the fruit juice as a diluent is also considered to be an external ingredient.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the disclosure. In the following description, various embodiments of the present disclosure are described with reference to the following drawings, in which:

FIG. 1 shows a juice filtration system and a method for making a fruit beverage in accordance with some embodiments of the disclosure.

FIG. 2 shows a juice filtration system and a method for making a fruit beverage in accordance with other embodiments of the disclosure.

### DETAILED DESCRIPTION

In certain embodiments, the present disclosure relates to a method of making a fruit beverage using a juice filtration system to reduce the calorie and sugar contents, reduce bitterness, preserve the natural characteristics of the fruit, and improve palatability and tastefulness of the fruit beverage.

Method of Making a Fruit Beverage

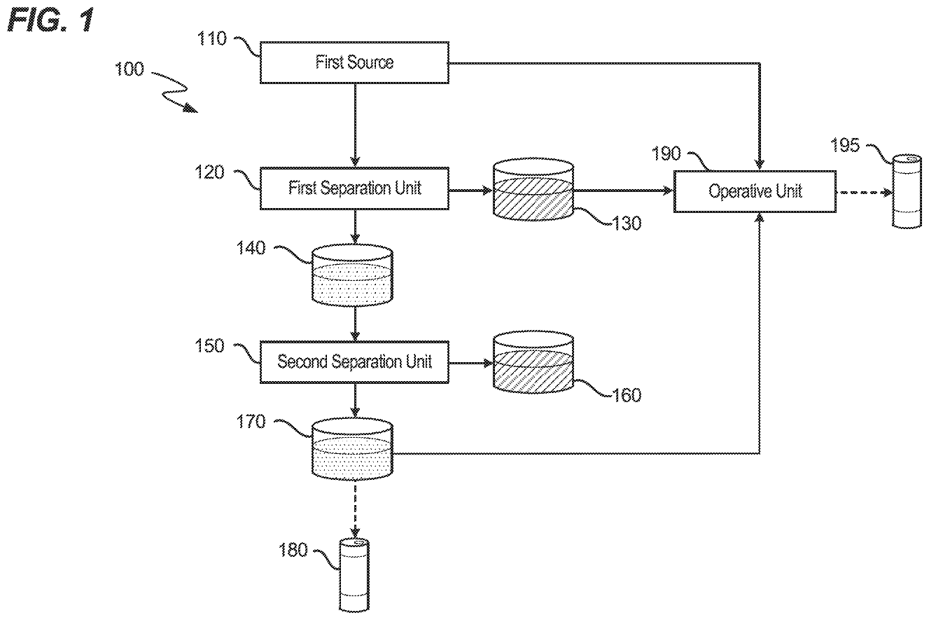

FIG. 1 shows a juice filtration system 100 for reducing contents of sugars and bitter substances of a feed juice and making a fruit beverage product in accordance with embodiments of the disclosure. The system 100 comprises a first separation unit 120 and a second separation unit 150. In certain embodiments, the system 100 further comprises an operative unit 190.

In some embodiments, the method of making a fruit beverage comprises providing a feed juice 110, passing the feed juice through the first separation unit 120 whereby generating a first retentate 130 and a first permeate 140; passing the first permeate 140 through a second separation unit 150 whereby generating a second retentate 160 and a second permeate 170, whereby forming a permeate-based fruit beverage 180 consisting essentially of the second permeate 170. In other embodiments, the method of making a fruit beverage further comprises selectively combining at least one component selected from the group consisting of the feed juice 110, the first retentate 130, the second permeate 170, and combinations thereof, using the operative unit 190, whereby forming the fruit beverage 195.

Feed Juice The system 100 includes providing a feed juice derived front a first fruit (referring to the first source 110 of FIG. 1). In one embodiment, the first fruit is a citrus fruit, and the resulting product is a citrus beverage. Citrus fruits generally refer to products of flowering trees and shrubs in the rue family, Rutaceae. Citrus fruit includes important crops such as oranges, lemons, grapefruits, pomelos, limes, and various true or hybrid cultivars thereof. In one embodiment, the first fruit is orange and the feed juice is an orange juice. Filtering juices and making beverages from other fruit(s) is also useful. In some embodiments, the first fruit contains two or more distinct fruits resulting in the feed juice derived from the two or more distinct fruits, for example, orange and grapefruit.

In some embodiments, the feed juice is derived from a juice concentrate. In preferred embodiments, the feed juice comprises a single strength juice or NFC. Typically, the NFC has a Brix value in a range from about 8° to about 25°, or from about 10° to 14°, or from about 10° to about 12.5°, or from about 10° to about 11.5°. In one embodiment, the NFC has a Brix of at least about 8°, or at least about 10°. The use of a NEC with other Brix values are also useful. The feed juice can include various nutritional ingredients such as vitamins and minerals as desired. To preserve the natural characteristics of the fruit and maintain to the maximal extent the original flavor, taste, and appearance of the feed juice, no external ingredient or food additive is added unless necessary for the purpose of safety or regulation. The food additive herein generally refers to commonly used substances in food industry, including but not limited to acidulents, antifoaming agents, food coloring, emulsifiers, artificial flavors, flavor enhancers, glazing agents, humectants, tracer gas, preservatives, artificial sweeteners, thickeners, etc.

In some embodiments, the feed juice contains natural sugars including but not limited to sucrose, glucose, and fructose, with a concentration of total sugars in a range from about 5 g/100 g to about 20 g/100 g, or from about 6 g/100 g to about 15 g/100 g, or from about 7 g/100 g to about 10 g/100 g, or from about 7.5 g/100 g to about 9.5 g/100 g, or from about 7.5 g/100 g to about 8.5 g/100 g. In some embodiments, the feed juice has a concentration of sucrose in a range from about 2 g/100 g to about 10 g/100 g, or from about 3 g/100 g to about 8 g/100 g, or from about 3.5 g/100 g to about 6 g/100 g, or from about 3.5 g/100 g, to about 4.5 g/100 g. In some embodiments, the feed juice has a concentration of glucose in a range from about 1 g/100 g to about 8 g/100 g, or from about 1.5 g/100 g to about 5 g/100 g, or from about 1.7 g/100 g to about 2.5 g/100 g, or from about 1.9 g/100 g to about 2.2 g/100 g. In some embodiments, the feed juice has a concentration of fructose in a range from about 1 g/100 g to about 8 g/100 g, or from about 1.5 g/100 g to about 5 g/100 g, or from about 1.7 g/100 g to about 2.5 g/100 g, or from about 1.9 g/100 g to about 2.2 g/100 g.

In some embodiments of the feed juice, sucrose attributes from about 30% to about 70% of the total sugar, or from about 40% to about 60% of the total sugar, or from about 45% to about 55% of the total sugar. In some embodiments, glucose attributes from about 10% to about 40% of the total sugar, or from about 15% to about 35% of the total sugar, or from about 20% to about 30% of the total sugar. In some embodiments, fructose attributes from about 10% to about 40% of the total sugar, or from about 15% to about 35% of the total sugar, or from about 20% to about 30% of the total sugar. In certain embodiments of the feed juice, sucrose attributes about 50% of the total sugar, glucose attributes about 25% of the total sugar, and fructose attributes about 25% of the total sugar.

In some embodiments, the feed juice contains natural limonoids, in particular, a limonin. In some embodiments, the feed juice has a limonin concentration in a range from about 1 mg/L to about 15 mg/L, or from about 2 to about 12 mg/L, or from about 2.5 to about 10 mg/L, or from about 2.7 mg/L to about 8 mg/L, or from about 3 mg/L to about 6 mg/L.

In certain embodiments, the feed juice contains natural Vitamin C. In some embodiments, the feed juice has a concentration of Vitamin C in a range from 10 mg/100 mL to 100 mg/100 mL, or from 20 mg/100 mL, to about 80 mg/100 mL, or from 30 mg/100 mL to about 70 mg/100 mL, or from 30 mg/100 mL to about 50 mg/100 mL, or from 35 mg/100 mL to about 45 mg/100 mL.

Referring to Table 1 below, the ranges and optimal ranges of the above references contents is provided as illustrative, non-limiting examples:

| | NFC Orange Juice | | Final Product | |
|---|---|---|---|---|
| | | Optimal | | Optimal |
| Attribute | Range | Range | Range | Range |
| Brix | 10.0-12.5 | 10.0-11.5 | 6.5-7.5 | 6.8-7.2 |
| Total Sugars | 7.5-9.5 | 7.5-8.5 | 4.5-5.5 | 4.5-5.5 |
| g/100 mL | | | | |
| Sucrose g/100 mL | 3.5-5.0 | 3.5-4.5 | 1.8-2.2 | 1.8-2.2 |
| Glucose g/100 mL | 1.7-2.5 | 1.9-2.2 | 1.2-1.6 | 1.2-1.6 |
| Fructose g/100 mL | 1.7-2.5 | 1.9-2.2 | 1.3-1.7 | 1.3-1.7 |
| Vitamin C | 30-50 | 35-45 | 45-55 | 48-52 |
| mg/100 mL | | | | |
| Limonin | 1.0-7.0 | 3.0-6.0 | 0.5-4.0 | 1.0-3.0 |
| Brix | 10.0-12.5 | 10.0-11.5 | 6.5-7.5 | 6.8-7.2 |
| Total Sugars | 7.5-9.5 | 7.5-8.5 | 4.5-5.5 | 4.5-5.5 |
| g/100 mL | | | | |
| Sucrose (% of tot. | 50% | 50% | 35-45% | 35-45% |
| sugar) | | | | |
| Glucose (% of tot. | 25% | 25% | 25-35% | 25-35% |
| sugar) | | | | |
| Fructose (% of tot. | 25% | 25% | 25-35% | 25-35% |
| sugar) | | | | |

First Separation

The feed juice is subject to the step of passing through the first separation unit 120, whereby generating a first retentate 130 and a first permeate 140. In some embodiments, the first retentate comprises suspended solids, wherein the suspended solids are not substantially different from the feed juice with respect to Brix value, sugar concentration, Vitamin C concentration, and limonin concentration. In some embodiments, the first permeate comprises a clarified liquid. In certain embodiments, the clarified liquid is a clear liquid that is substantially free of solids or particulates that are visible to eyes. In other embodiments, the first permeate is partially clear, comprising visible solids possibly resulted from agglomeration of smaller particles in the first permeate. In yet other embodiments, the clarified liquid is cloudy or partially cloudy, containing a noticeable amount of visible solids. It is noted that the clarity of the first permeate is unrelated to effectiveness or efficiency of passing the feed juice through the first separation unit.

In other related embodiments, the first retentate comprises suspended solids that are not substantially different from the feed juice with respect to Brix value, sugar concentration, Vitamin C concentration, and limonin concentration. In other embodiments, the °Brix of the first permeate is reduced, compared to the feed juice, by about 1% to about 20%.

In some embodiments, the Vitamin C concentration of the first retentate is reduced, compared with the feed juice, by about 1% to about 20%. In other embodiments, the Vitamin C concentration of the first permeate is increased, compared with the feed juice, by a number in a range from about 1% to about 20%.

In some embodiments, the limonin concentration of the first retentate is not significant changed compared with the feed juice. In other embodiments, the limonin concentration or the first retentate is reduced, compared with the feed juice, by about 1% to about 20%. In yet other embodiments, the limonin concentration of the first retentate is increased, compared with the feed nice, by about 1% to about 20%.

In related embodiment, the first retentate has a Brix value in a range from about 8° to about 25°, or from about 9° to about 20°, or from about 10° to about 15°.

In some embodiments, the first retentate contains one of more natural sugars including but not limited to sucrose, glucose, and fructose, with a concentration of total sugars in a range from about 6 g/100 g to about 20 g/100 g, or from about 7 g/100 g to about 15 g/100 g, or from about 8 g/100 g to about 10 g/100 g. In some embodiments, the first retentate has a concentration of sucrose in a range from about 2 g/100 g to about 20 g/100 g, or from about 3 g/100 g to about 15 g/100 g, or from about 4 g/ 100 g to about 10 g/100 g. In some embodiments, the first retentate has a concentration of glucose in a range from about 1 g/100 g to about 10 g/100 g, or from about 1.5 g/100 g to about 8 g/100 g, or from about 2 g/100 g to about 5 g/100 g. In some embodiments, the first retentate has a concentration of fructose in a range from about 1 g/100 g to about 10 g/100 g, or from about 1.5 g/100 g to about 8 g/100 g, or from about 2 g/100 g to about 5 g/100 g.

In at least one example embodiment, the first retentate has a Vitamin C concentration in a range from 10 mg/100 mL, to 60 mg/100 mL. In some embodiments, the first retentate has a limonin concentration in a range from about 2.7 mg/mL, to about 6 mg/L.

In some embodiments, the first permeate comprises suspended solids that are not substantially different from the feed juice with respect to Brix value, sugar concentration, Vitamin C concentration, and limonin concentration. In other embodiments, the °Brix of the first permeate is reduced, compared with the feed juice, by about 1% to about 20%, or from 3% to about 18%, or from 5% to about 16%, or from about 7% to about 15%, or from about 9% to about 13%, or from about 10% to about 12%.

In related embodiments, the Vitamin C concentration of the first permeate is reduced, compared with the feed juice, by about 1% to about 20%. In other embodiments, the Vitamin C concentration of the first permeate is increased, compared with the feed juice, by a number in a range from about 1% to about 20%.

In at least one example embodiments, the limonin concentration of the first permeate is reduced, compared with the feed juice, by about 1% to about 80%, or by about 5% to about 70%, or by about 10% to about 60%, or by about 15% to about 50%, or by about 20% to about 40%, or by about 25% to about 30%.

In some embodiment, the first permeate has a Brix value in a range from about 8° to about 25°, or from about 9° to about 20°, or from about 10° to about 15°.

In some embodiments, the first permeate contains sucrose, glucose, and fructose, with a concentration of total sugars in a range from about 6 g/100 g to about 20 g/100 g, or from about 7 g/100 g to about 15 g/100 g, or from about 8 g/100 g to about 10 g/100 g. In some embodiments, the first permeate has a concentration of sucrose in a range from about 2 g/100 g to about 20 g/100 g, or from about 3 g/100 g to about 15 g/100 g, or from about 4 g/100 g to about 10 g/100 g. In some embodiments, the first permeate has a concentration of glucose in a range from about 1 g/100 g to about 10 g/100 g, or from about 1.5 g/100 g to about 8 g/100 g, or from about 2 g/100 g to about 5 g/100 g. In some embodiments, the first permeate has a concentration of fructose in a range from about 1 g/100 g to about 10 g/100 g, or from about 1.5 g/100 g to about 8 g/100 g, or from about 2 g/100 g to about 5 g/100 g.

In some embodiment, the first permeate has a Vitamin C concentration in a range from 10 mg/100 mL, to 60 mg/100 mL In some embodiments, the first permeate has a limonin concentration in a range from about 0.5 mg/L to about 6 mg/L.

The sugars, Vitamin C, limonin in the first permeate and the first retentate are all originated from the feed juice.

Second Separation

The first permeate 140 is further subject to the step of passing through the second separation unit 150 whereby generating a second retentate 160 and a second permeate 170. The second retentate is a sugar-rich composition, while the second permeate is a “water-like” liquid with low sugar content.

In some embodiments, the second retentate comprises solids originated from the first permeate. In other embodiments, the second retentate is a substantially clear liquid. In some embodiments, the second permeate comprises a clarified liquid. In some embodiments, the second permeate is a sufficiently clear liquid that is substantially free of solids or particulates that are visible to eyes. In other embodiments, the second permeate is partially clear, comprising visible solids possibly resulted from agglomeration of smaller particles. It is noted that the clarity of the first permeate is unrelated to effectiveness or efficiency of step of passing the first permeate through the second separation unit.

In some embodiments, the second retentate comprises suspended solids that are noticeably different from the feed juice with respect to Brix value, sugar concentration, Vitamin C concentration, and limonin concentration. In certain embodiments, the °Brix of the second retentate is increased, compared with the first permeate, by about 100% to about 200%. In some embodiments, the concentration of total sugars of the second retentate is increased, compared with the first permeate, by about 100% to about 200%. In some embodiments, the concentration of sucrose of the second retentate is increased, compared with the first permeate, by about 100% to about 200%. In some embodiments, the concentration of glucose of the second retentate is increased, compared with the first permeate, by about 100% to about 200%. In some embodiments, the concentration of fructose of the second retentate is increased, compared with the first permeate, by about 100% to about 200%

In some embodiments, the Vitamin C concentration of the second retentate is increased, compared with the first permeate, by about 10% to about 100%.

In some embodiments, the limonin concentration of the second retentate is increased, compared with the first permeate, by about 100% to about 250%.

In some embodiment, the second retentate has a Brix value in a range from about 20° to about 30°. In some embodiments, the second retentate contains sucrose, glucose, and fructose, with a concentration of total sugars in a range from about 10 g/100 g to about 30 g/100 g. In some embodiments, the second retentate has a concentration of sucrose in a range from about 10 g/100 g to about 20 g/100 g. In some embodiments, the second retentate has a concentration of glucose in a range from about 3 g/100 g, to about 8 g/100 g. In some embodiments, the second retentate has a concentration of fructose in a range from about 3 g/100 g to about 8 g/100 g.

In some embodiment, the second retentate has a Vitamin. C concentration in a range from 20 mg/100 mL to 80 mg/100 mL, or from 30 mg/100 mL to 60 mg/100 mL, or from 40 mg/100 mL to 50 mg/100 mL. In some embodiments, the second retentate has a limonin concentration in a range from about 2 mg/L to about 10 mg/L, or from about 3 mg/L to about 8 mg/L or from about 3.4 mg/L to about 6 mg/L.

In some embodiments, the second permeate comprises suspended solids that are noticeably different from the feed juice with respect to Brix value, sugar concentration, Vitamin C concentration, and limonin concentration. In certain embodiments, the °Brix of the second permeate is reduced, compared with the first permeate, by about 30% to about 90%. In some embodiments, the concentration of total sugars of the second permeate is reduced, compared with the first permeate, by about 30% to about 90%. In some embodiments, the concentration of sucrose of the second permeate is reduced, compared with the first permeate, by about 30% to about 90%. In some embodiments, the concentration of glucose of the second permeate is reduced, compared with the first permeate, by about 20% to about 80%. In some embodiments, the concentration of fructose of the second retentate is increased, compared with the first permeate, by about 20% to about 80%.

In some embodiments, the Vitamin C concentration of the second permeate is reduced, compared with the first permeate, by about 10% to about 50%.

In some embodiments, the limonin concentration of the second permeate is reduced, compared with the first permeate, by about 70% to about 100%. In certain embodiments, the limonin centration is reduced by at least 90%.

In some embodiment, the second permeate has a Brix value in a range from about 2° to about 8°. In some embodiments, the second permeate contains sucrose, glucose, and fructose, with a concentration of total sugars in a range from about 0.5 g/100 g to about 5 g/100 g. In some embodiments, the second retentate has a concentration of sucrose in a range from about 0.2 g/100 g to about 2 g/100 g. In some embodiments, the second permeate has a concentration of glucose in a range from about 0.2 g/100 g to about 2 g/100 g. In some embodiments, the second permeate has a concentration of fructose in a range from about 0.2 g/100 g to about 2 g/100 g.

In some embodiment, the second permeate has a Vitamin C concentration in a range from 10 mg/100 mL to 40 mg/100 mL. In certain embodiments, the second permeate has a Vitamin C concentration of at most 25 mg/100 mL. In some embodiments, the second permeate has a limonin concentration in a range from about 0 to about 0.5 mg/L.

The second permeate may by itself serve as permeate-based fruit beverage 180, which thereby inherits the characteristics of the second permeate; while the second retentate, which is a sugar-rich by-product, can be used as a supplementary sweetener for other food products.

In some embodiments, the permeate-based fruit beverage 180 has a significantly lower Brix value and sugar contents compared with the feed juice. For example, the °Brix of the permeate-based fruit beverage 180 is reduced, compared with the feed juice, by about 20% to about 90%, or by about 30% to about 80%, or by about 40% to about 70%, or by about 50% to about 60%. In some embodiments, the concentration of total sugars of the permeate-based fruit beverage 180 is reduced, compared with the feed juice, by about 20% to about 90%, or by about 30% to about 80%, or by about 40% to about 70%, or by about 50% to about 60%. In some embodiments, the concentration of sucrose of the permeate-based fruit beverage 180 is reduced, compared with the feed juice, by about 20% to about 90%, or by about 30% to about 80%, or by about 40% to about 70%, or by about 50% to about 60%. In some embodiments, the concentration of glucose of the permeate-based fruit beverage 180 is reduced, compared with the feed juice, by about 20% to about 90%, or by about 30% to about 80%, or by about 40% to about 70%, or by about 50% to about 60%. In some embodiments, the concentration of fructose of the permeate-based fruit beverage 180 is reduced, compared with the feed juice, by about 20% to about 90%, or by about 30% to about 80%, or by about 40% to about 70%, or by about 50% to about 60%.

In some embodiments, the Vitamin C concentration of the permeate-based fruit beverage 180 is decreased, compared with the feed juice, by about 1% to about 50%, or by about 5% to about 40%, or by about 10% to about 30%, or by about 10% to about 20%, or by about 15% to about 18%.

In some embodiments, the limonoid concentration of the permeate-based fruit beverage 180 is reduced, compared with the feed juice, by at least about 7%. In certain embodiments, the limonin concentration of the permeate-based fruit beverage 180 is reduced by at least about 10% or at least about 20% or at least about 30% or at least about 40% or at least about 50% or at least about 60% or at least about 70% or at least about 80% or at least about 90% or at least about 99%, compared with the feed juice.

In some embodiments, the permeate-based fruit beverage 180 has a Brix value in a range from about 2° to about 8°, or from 3° to about 6°, or from 4° to about 5°. In some embodiments, the permeate-based fruit beverage 180 contains sucrose, glucose, and fructose, with a concentration of total sugars in a range from about 0.5 g/100 g to about 5 g/100 g, or from about 1 g/100 g to about 4 g/100 g, or from 2 g/100 g to about 3 g/100 g. In some embodiments, the permeate-based fruit beverage 180 has a concentration of sucrose in a range from about 0 to about 2 g/100 g, or from about 0.2 g/100 g to about 1.8 g/100 g, or from about 0.5 g/100 g to about 1.5 g/100 g, or from about 0.8 g/100 g to about 1.2 g/100 g. In some embodiments, the permeate-based fruit beverage 180 has a concentration of glucose in a range from about 0 to about 2 g/100 g, or from about 0.2 g/100 g to about 1.8 g/100 g, or from about 0.5 g/100 g to about 1.5 g/100 g, or from about 0.8 g/100 g to about 1.2 g/100 g. In some embodiments, the permeate-based fruit beverage 180 has a concentration of fructose in a range from about 0 to about 2 g/100 g, or from about 0.2 g/100 g to about 1.8 g/100 g, or from about 0.5 g/100 g to about 1.5 g/100 g, or from about 0.8 g/100 g to about 1.2 g/100 g.

In some embodiment, the permeate-based fruit beverage 180 has a Vitamin C concentration in a range from about 10 mg/100 mL to about 50 mg/100 mL, or from about 20 mg/100 mL to about 40 mg/100 mL, or from about 35 mg/100 mL to about 45 mg/100 mL. In certain embodiments, the permeate-based fruit beverage 180 has a Vitamin C concentration of at least 30 mg/100 mL. In some embodiments, the permeate-based fruit beverage 180 has a limonoid concentration in a range from about 0 to about 2 mg/L, or from about 0.2 mg/L, to about 1.8 mg/L, or from about 0.5 mg/L to about 1.5 mg/L, or from about 0.8 mg/L to about 1.2 mg/L. In certain embodiments, the permeate-based fruit beverage 180 has a limonin concentration in a range from about 0 to about 0.3 mg/L.

Combination

The method of making the fruit beverage comprises a step of selectively combining various components selected from the group consisting of 110, 130, 170, and combinations thereof, to form the fruit beverage 195 using an operative unit 190. Combining herein refers to collecting, blending, and mixing all the desired components in one place and form a homogeneous mixture thereof. Selected components may be added simultaneously or sequentially during the combining step. The addition of each component may be continuous or in portions.

In some embodiments, the combining step includes combing a portion of the second permeate, a portion of the first retentate, and a portion of the feed juice whereby generating the fruit beverage 195 . In some embodiments, accordingly, the fruit beverage 195 comprises fruit solids, sugars, Vitamin C, and limonin, all originated from the feed juice, wherein the fruit beverage has a 100% identity to the feed juice, free from external ingredient.

In some embodiments, the fruit beverage 195 has a significantly lower Brix value and sugar contents compared with the feed juice. For example, the °Brix of the fruit beverage 195 is reduced, compared with the feed juice, by about 20% to about 90%, or by about 30% to about 80%, or by about 40% to about 70%, or by about 50% to about 60%. In sonic embodiments, the concentration of total sugars of the fruit beverage 195 is reduced, compared with the feed juice, by about 20% to about 90%, or by about 30% to about 80%, or by about 40% to about 70%, or by about 50% to about 60%. In some embodiments, the concentration of sucrose of the fruit beverage 195 is reduced, compared with the feed juice, by about 20% to about 90%, or by about 30% to about 80%, or by about 40% to about 70%, or by about 50% to about 60%. In some embodiments, the concentration of glucose of the fruit beverage 195 is reduced, compared with the feed juice, by about 20% to about 90%, or by about 30% to about 80%, or by about 40% to about 70%, or by about 50% to about 60%. In some embodiments, the concentration of fructose of the fruit beverage 195 is reduced, compared with the feed juice, by about 20% to about 90%, or by about 30% to about 80%, or by about 40% to about 70%, or by about 50% to about 60%.

In some embodiments, the Vitamin C concentration of the fruit beverage 195 is increased, compared with the feed juice, by about 1% to about 50%, or from about 10% to about 40%, or from about 15% to about 35%, or from about 20% to about 30%.

In some embodiments, the limonin concentration of the fruit beverage 195 is reduced, compared with the feed juice, by at least about 7% or at least about 10% or at least about 20% or at least about 30% or at least about 40% or at least about 50% or at least about 60% or at least about 70% or at least about 80% or at least about 90% or at least about 99%, compared with the feed juice.

In some embodiments, the fruit beverage 195 has a Brix value in a range from about 2° to about 8°, or from 3° to about 6°, or from 4° to about 5°. In some embodiments, the fruit beverage 195 contains sucrose, glucose, and fructose, with a concentration of total sugars in a range from about 0.5 g/100 g to about 5 g/100 g, or from about 1 g/100 g to about 4 g/100 g, or from 2 g/100 g to about 3 g/100 g. In some embodiments, the fruit beverage 195 has a concentration of sucrose in a range from about 0 to about 3 g/100 g, or from about 0.5 g/100 g to about 2.5 g/100 g, or from about 1 g/100 g to about 2 g/100 g, or from about 1.3 g/100 g to about 1.7 g/100 g. In some embodiments, the fruit beverage 195 has a concentration of glucose in a range from about 0 to about 2 g/100 g, or from about 0.2 g/100 g to about 1.8 g/100 g, or from about 0.5 g/100 g to about 1.5 g/100 g, or from about 0.8 g/100 g to about 1.2 g/100 g. In some embodiments, the fruit beverage 195 has a concentration of fructose in a range from about 0.2 g/100 g to about 2 g/100 g, or from about 0.2 g/100 g to about 1.8 g/100 g, or from about 0 5 g/100 g to about 1.5 g/100 g, or from about 0.8 g/100 g to about 1.2 g/100 g.

In some embodiment, the fruit beverage 195 has a Vitamin C concentration in a range from 10 mg/100 mL to 50 mg/100 mL, or from 20 mg/100 mL to 40 mg/100 mL, or from about 25 mg/100 mL to about 35 mg/100 mL. In certain embodiments, the fruit beverage 195 has a Vitamin C concentration of at least 30 mg/100 mL. In some embodiments, the fruit beverage 195 has a limonoid concentration in a range from about 0 to about 4 mg/100 mL, or from about 0.5 mg/100 mL to about 3.5 mg/L or from about 1 mg/L to about 3 mg/L, or from about 1.5 mg/L to about 2.5 mg/L, or from about 1.7 mg/L to about 2.2 mg/L.

Adding Components from a Second Fruit Source

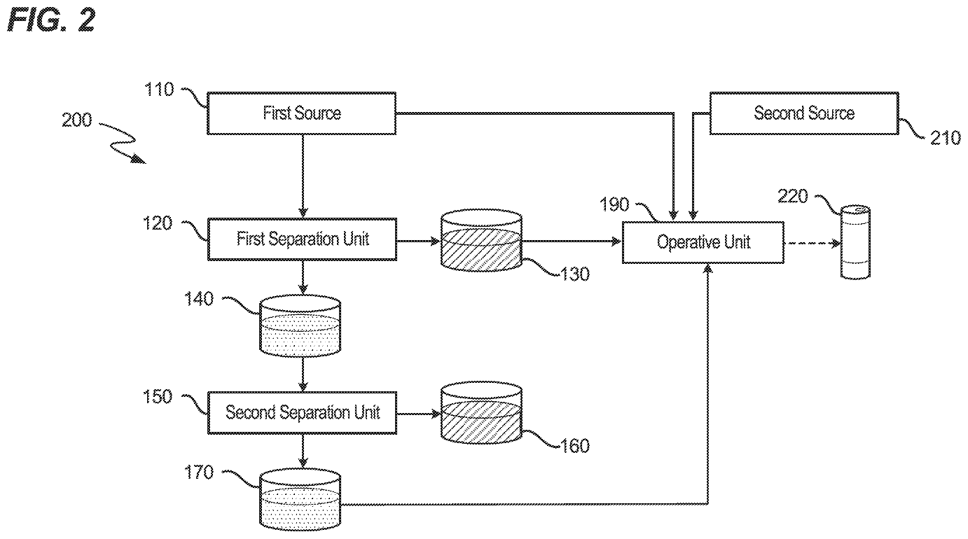

FIG. 2 shows another example embodiment of a juice filtration system 200 for reducing contents of sugars and bitterness-inducing substances of a feed juice and making a fruit beverage product in accordance with embodiments of the disclosure. The system 200 is substantially the same as the system 100 with an exception that a portion of a second fruit source 210 may be added during the combing step to form a further fruit beverage 220 comprising the second fruit source. Accordingly, the method of making the further fruit beverage 220 comprises providing a feed juice 110, passing the feed juice 110 through the first separation unit 120 whereby generating a first retentate 130 and a first permeate 140, passing the first permeate through a second separation unit 150 whereby generating a second retentate 160 and a second permeate 170, and selectively combining components using an operative unit, wherein the components are selected from the group consisting of the feed juice, the first retentate, the second permeate, a portion of a second fruit source, and combinations thereof.

The second fruit source 210 can be derived from a second fruit that can be the same as or distinct front the fruit of the feed juice. The second fruit source can be derived from two or more fruits, wherein at least one of the two or more fruits is distinct from the first fruit of the feed juice. In some embodiments, the feed juice is a citrus juice, and the second fruit source is an orange pulp. In other embodiments, the feed juice is a citrus juice, and the second fruit source is an acerola. In yet other embodiments, the feed juice is a citrus juice, and the second fruit source is a monk fruit. In yet other embodiments, the feed juice is derived from two or more fruits wherein at least one fruit is citrus, and the second fruit source is derived from two or more fruits wherein at least one fruit is not the same fruit as the feed juice.

Acerola, or acerola cherry (scientific name: Malpighia emarginata DC), is a fruit extremely rich in Vitamin C. Acerola can be used as an active ingredient for a skin-whitening agent. Acerola cherry can also be used as an astringent, making it helpful for treating skin blemishes, promoting skin elasticity, and aiding digestive issues. Acerola may even be used for antimicrobial mouthwash, antidepressant, antifungal, athletic endurance, diarrhea, dysentery, skin astringent (cream). Because the juice filtration process may filter out Vitamin C, adding a portion of acerola source to the permeate products may help to recover the Vitamin C content of the fruit beverage products.

Monk fruit, also known by its Chinese name luo ban guo (Siraitia grosvenorii, formerly known as Momordica grosvenorii) is a fruit of the Cucurbitaceae family, which is one source for naturally-occurring terpene glycosides such as mogrosides and siamenosides. These terpene glycosides are a class of non-calorie sweeteners. For, example, the most abundant mogroside in monk fruit is mogroside V, which has been estimated to have a sweetness of approximately 250 times cane sugar on a weight basis. Therefore, adding a portion of monk fruit source to the fruit beverage may improve the sweetness of the beverage while not increasing the calorie level.

In some embodiments, the second fruit source is derived from acerola fruit such as juice, pulp, puree, suspension, solids, or combinations thereof. In some embodiments, the second fruit source is a NFC acerola puree having a Vitamin C concentration oft least 1500 mg/100 mL. In some embodiments, the second fruit source is derived from monk fruit such as juice, pulp, solids, or combination thereof. In other embodiments, the second fruit source is derived from both acerola and monk fruit. In yet other embodiments, the second source is derived from three or more fruits, for example, from acerola, monk fruits, and orange. In certain embodiments, the second fruit source is derived from orange pulp, NFC acerola puree, and monk fruit juice. Accordingly, in certain embodiments, the fruit beverage comprises fruit solids, sugars, Vitamin C, and limonoid, all originated from the feed juice and/or the second fruit source. The fruit beverage has a 100% identity to the fruit(s) from both the feed juice and the second fruit source, free or substantially free from external ingredient.

The fruit beverages derived from two or more distinct fruits may have different flavors or taste characteristics depending on the wt % of each of the fruits in the beverage. In some embodiments, such beverage has a single flavor that is substantially the same as the flavor of the feed juice, for example, an orange juice. In other embodiments, such beverage may have a “blended” flavor or mixed characteristic. For example, the beverage made from a feed juice from orange and a second source from acerola may present a unique flavor or taste that resembles blended orange and acerola. In yet other embodiments, however, the flavor or taste of each constituent fruit may not be identifiable in the fruit beverage.

In some embodiments, the further fruit beverage 220 as described herein has a significantly lower Brix value and sugar contents compared with the feed juice. For example, the °Brix of the further fruit beverage 220 is reduced, compared with the feed juice, by about 20% to about 90%, or by about 30% to about 80%, or by about 40% to about 70%, or by about 50% to about 60%. In some embodiments, the concentration of total sugars of the further fruit beverage 220 is reduced, compared with the feed juice, by about 20% to about 90%, or by about 30% to about 80%, or by about 40% to about 70%, or by about 50% to about 60%. In some embodiments, the concentration of sucrose of the further fruit beverage 220 is reduced, compared with the feed juice, by about 20% to about 90%, or by about 30% to about 80%, or by about 40% to about 70%, or by about 50% to about 60%. In some embodiments, the concentration of glucose of the further fruit beverage 220 is reduced, compared with the feed juice, by about 20% to about 90%, or by about 30% to about 80%, or by about 40% to about 70%, or by about 50% to about 60%. In some embodiments, the concentration of fructose of the further fruit beverage 220 is reduced, compared with the feed juice, by about 20% to about 90%, or by about 30% to about 80%, or by about 40% to about 70%, or by about 50% to about 60%.

In some embodiments, the Vitamin C concentration of the further fruit beverage 220 is increased, compared with the feed juice, by about 1% to about 100%, or from about 10% to about 90%, or from about 20% to about 80%, or from about 30% to about 70%, or from about 40% to about 60%, or from about 45% to about 55%.

In some embodiments, the limonin concentration of the further fruit beverage 220 is reduced, compared with the feed juice, by at least about 7% or at least about 10% or at least about 20% or at least about 30% or at least about 40% or at least about 50% or at least about 60% or at least about 70% or at least about 80% or at least about 90% or at least about 99%.

In some embodiment, the further fruit beverage 220 has a Brix value in a range from about 2° to about 10°, or from about 3° to about 9°, or from about 4° to about 8°, or from about 5° to about 8°, or from about 6° to about 8°, or from about 6.5° to about 7.5, or from about 6.8° to about 7.2°. In some embodiments, the further fruit beverage 220 has a Brix value that is ≤about 12°, about ≤10°, ≤about 8°, ≤about 6°, or ≤about 4°.

In some embodiments, the further fruit beverage 220 contains sucrose, glucose, and fructose, with a concentration of total sugars in a range from about 2 g/100 g to about 8 g/100 g, or from about 3 g/100 g to about 7 g/100 g, or from about 4 g/100 g to about 6 g/100 g, or from about 4.5 g/100 g to about 5 g/100 g. In some embodiments, the further fruit beverage 220 has a total sugars concentration that is about ≤10 g/100 g, ≤about 8 g/100 g, ≤about 6 g/100 g, ≤about 4 g/100 g, or ≤about 2 g/100 g.

In some embodiments, the further fruit beverage 220 has a concentration of sucrose in a range from 0.5 g/100 g to about 5 g/100 g, or from about 1 g/100 g to about 4 g/100 g, or from about 1.5 g/100 g to about 3 g/100 g, or from about 1.8 g/100 g to about 2.5 g/100 g, or from about 1.8 g/100 g to about 2.2 g/100 g. In some embodiments, the further fruit beverage 220 has a sucrose concentration that is ≤about 5 g/100 g, ≤about 4 g/100 g, ≤about 3 g/100 g, ≤about 2 g/100 g, or ≤about 1 g/100 g.

In some embodiments, the further fruit beverage 220 has a concentration of glucose in a range from 0.5 g/100 g to about 4 g/100 g, or from about 1 g/100 g to about 3 g/100 g, or from about 1 g/100 g to about 2 g/100 g, or from about 1.2 g/100 g to about 1.6 g/100 g. In some embodiments, the further fruit beverage 220 has a glucose concentration that ≤about 5 g/100 g, ≤about 4 g/100 g, ≤about 3 g/100 g, ≤about 2 g/100 g, or ≤about 1 g/100 g.

In some embodiments, the further fruit beverage 220 has a concentration of fructose in a range from 0.5 g/100 g to about 4 g/100 g, or from about 1 g/100 g to about 3 g/100 g, or from about 1 g/100 g to about 2 g/100 g, or from about 1.2 g/100 g to about 1.6 g/100 g. In some embodiments, the further fruit beverage 220 has a fructose concentration that ≤about 5 g/100 g, ≤about 4 g/100 g, ≤about 3 g/100 g, about 2 g/100 g, or ≤about 1 g/100 g.

In some embodiments of the further fruit beverage 220, sucrose attributes from about 20% to about 60% of the total sugar, or from about 30% to about 50% of the total sugar, or from about 35% to about 45% of the total sugar. In some embodiments, glucose attributes from about 10% to about 50% of the total sugar, or from about 20% to about 40% of the total sugar, or from about 25% to about 35% of the total sugar. In some embodiments, fructose attributes from about 10% to about 50% of the total sugar, or from about 20% to about 40% of the total sugar, or from about 25% to about 35% of the total sugar. In some embodiment, the further fruit beverage 220 has a Vitamin C concentration in a range from about 20 mg/100 mL to about 80 mg/100 mL. In some embodiments the fruit beverage has a Vitamin C concentration that is ≤about 20 mg/100 mL or more, ≤about 30 mg/100 mL, ≤about 40 mg/100 mL, ≤about 50 mg/100 mL, ≤about 60 mg/100 mL, ≤about 70 mg/100 mL, or about 80 mg/100 mL.

In some embodiments, the further fruit beverage 220 has a limonoid concentration in a range from about 0 to about 4 mg/L, or from about 0.5 mg/L to about 3.5 mg/L, or from about 1 mg/L to about 3 mg/L, or from about 1.5 mg/L to about 2.5 mg/L, or from about 1.7 mg/L to about 2.2 mg/L.

Given that the concentration range of each ingredient of each component (feed juice, first retentate, second permeate, and second fruit source) is known or obtainable, a skilled artisan would be able to calculate the required amount or the range of amount of each component, and combine the calculated components accordingly to produce the fruit beverage with desired ranges of ingredients.

The present method of making fruit beverages may optionally include a final step of sterilization and package (not shown in FIGS. 1 and 2) The beverage is packaged into, for example, jugs, cans, bottles, or otherwise suitable sealed containers.

The packaged products may be labeled and packed for shipping, distribution, and delivery.

Filtration Systems

In some embodiments, the juice filtration systems 100 and 200 as respectively shown in FIGS. 1 and 2 comprise a first separation unit 120 and a second separation unit 150. The first and the second separation units can be operated either successively in line or separately. The separation unit herein refers generally to standard processing facilities used for separation in food industry, including but limited to filtration, centrifuge, chromatography, extraction, flotation, precipitation, sedimentation, reverse osmosis, vacuum filtration, pressured filtration, ultra-filtration, etc.

In some embodiments, the juice filtration systems 100 and 200 each respectively further comprises an operative unit 190, wherein the operative unit is used for combining selected components to form the respective fruit beverage 195 or 220.

In some embodiments, the first separation unit comprises at least one micro-filtration unit (or coarse filtration unit), which receives the feed juice. The micro-filtration unit comprises a micro-filter medium, wherein the micro-filter medium can be a membrane, a fiber medium, or otherwise a device with porous features to allow a fluid to pass through. In some embodiments, the first retentate produced by micro-filtration is of about 2× to about 5× concentration. In certain embodiments, the first retentate is of about 3× to about 4× concentration. Other concentrations may also be useful. Higher concentrations may require extended process time and/or additional filtration units.

Various types of micro-filter are commercially available, for example, from Dow Chemical Company (US), SCT Membralox (France), or Koch Membrane Systems (US). The appropriate pore size of the micro-filter is selected to prevent the large molecules that are undesirable. In some embodiments, the pore size is from about 0.1 to about 10 micrometers. In certain embodiments, the pore size is from about 0.1 to about 3 micrometers, or from about 0.1 to about 0.3 micrometers.

The micro-filtration process is conducted following commonly used procedures in food industry. One skilled in the art is capable of optimizing processing conditions such as the pressure, flow rate, input and output settings to arrive at the desired outcome. In at least one example embodiment, the pressure is between 5-35 psi (first separation) and 350-450 psi (second separation).

The juice filtration system comprises a second separation unit to further clarify the first permeate generated from the first separation. In some embodiments, the second separation unit comprises at least one nano-filtration unit (or fine filtration unit) for the production of the second retentate and the second permeate. Nano-filtration employs a membrane having nanometer sized through-pores that pass through the membrane. Nano-filtration membranes have pore sizes from 1-10 nanometers, smaller than that used in micro-filtration and ultra-filtration. In some embodiments, the pore size of the nano-filter is about 1 nm, which corresponds to a molecular weight cut-off (MWCO) of about 200 Da. In other embodiments, the pore size of the nano-filter is in a range from about 0.5 nm to about 5 nm, which correlates to the MWCO range from about 100 Da to about 1,000 Da. In some embodiments, the pore size of the nano-filter correlates to the MWCO range from about 250 Da to about 800 Da. In other embodiments, the pore size of the nano-filter correlates to the MWCO range from about 300 Da to about 500 Da. In yet other embodiments, the pore size of the nano-filter correlates to the MWCO range from about 600 Da to about 800 Da. In some embodiments, the second retentate produced by micro-filtration is of about 2× to about 5× concentration. In certain embodiments, the second retentate is of about. 3× to about 4× concentration. Other concentrations may also be useful. Higher concentrations may require extended process time and/or additional filtration units.

While not wishing to be bonded by theory, it is important to note that, the molecular weight of limonin is 470.5 Da, which is within or close to the MWCO cut-off range of typical nano-filters. Therefore, limonin should be effectively (at least partially) retained during nano-filtration, and the resultant second permeate has a substantial reduction of limonin content compared with the first permeate prior to nanofiltration. In particular, if the MWCO of the nano-filter is significantly less than 470.5 Da (e.g., about 200 Da), limonin should be almost completely retained by nanofiltration and the resultant permeate should be free or substantially free from limonin, which substantially loses the “natural flavor or characteristics” of the fruit. In certain embodiments of the present disclosure, a portion of limonin-rich fruit sources, for example, the feed juice, or the second fruit source, is added to the second permeate to recover limonin content of the final fruit beverage to an appropriate level that balances the “natural flavor or characteristic” of the feed juice against bitterness of the fruits.

The juice filtration system and the filtration and combination steps for making beverage can be performed at various temperatures. The system can be operated at refrigerated temperature to improve the beverage quality and retain natural nutritional ingredients from the feed juice. However, operation temperature that is too low may negatively affect the efficiency, energy consumption, and cost control. In some embodiments, the juice filtration system is operated at a temperature less than 15°C., or in a range from about 4°C. to about 14°C., more specifically from about 8° C. to about 12°C. In other related embodiments the first separation is performed between about 0° C. to about 10°C. In other related embodiments the second separation is performed at a temperature between about 0° C. to about 10°C.

Fruit Beverage

In some embodiments, the present disclosure is generally related to a fruit beverage comprising fruit solids, Vitamin C, one of more natural sugars including but not limited to sucrose, glucose, fructose, or the combinations thereof, a limonoid, wherein the fruit solids, the Vitamin C, the sugar, and the limonoid are all originated from at least one juice of at least one fruit, and wherein the fruit beverage is free or substantially free of external ingredients. Such fruit beverage may encompass the product made according to the present disclosure,

In some embodiments, the present disclosure is related to the fruit beverage product made by fruit juice filtration system described herein, wherein the fruit beverage consists essentially of a second permeate, wherein the second permeate is produced by passing a first permeate through a second separation unit, wherein the first permeate is generated by passing a feed juice of a first fruit through a first separation unit.

In some embodiments, the present disclosure is related to the fruit beverage product made by the fruit juice filtration system described herein, wherein the fruit juice comprises a portion of a first retentate, wherein the first retentate is produced by passing a juice of a first fruit through a first separation unit, whereby a first permeate is also produced; and a portion of a second permeate, wherein the second permeate is produced by passing the first permeate through a second separation unit, whereby a second retentate is also produced, and wherein the fruit beverage comprises fruit solids, one or more natural sugar including but not limited to sucrose, glucose, fructose, or combinations thereof, Vitamin C, and limonoid, wherein the fruit solids, the Vitamin C, the sugar, and the limonoid are all originated from at least one juice of at least one fruit, and wherein the fruit beverage is free or substantially free of external ingredient In certain embodiments, the fruit beverage product further comprises a portion of the feed juice.

In some embodiments, the present disclosure is related to the fruit beverage made by a fruit juice filtration system, wherein the fruit beverage comprises a portion of a first retentate, wherein the first retentate is produced by passing a feed juice of a first fruit through a first separation unit, whereby a first permeate is also produced; a portion of a second permeate, wherein the second permeate is produced by passing the first permeate through a second separation unit, whereby a second retentate is also produced, and a portion of a second fruit source, wherein the fruit beverage comprises fruit solids, one or more natural sugars including but not limited to sucrose, glucose, fructose, or combinations thereof, Vitamin C, and limonoid, wherein the fruit solids, the Vitamin C, the sugar, and the limonoid are all originated from the feed juice of at least one fruit, and wherein the fruit beverage is free or substantially free of external ingredients. In certain embodiments, the fruit beverage product further comprises a portion of the feed juice.

In some embodiments, the fruit beverage as described herein has a significantly lower Brix value and sugar contents compared with the feed juice. For example, the °Brix of the fruit beverage is reduced, compared with the feed juice, by about 20% to about 90%, or by about 30% to about 80%, or by about 40% to about 70%, or by about 50% to about 60%. In some embodiments, the concentration of total sugars of the fruit beverage is reduced, compared with the feed juice, by about 20% to about 90%, or by about 30% to about 80%, or by about 40% to about 70%, or by about 50% to about 60%. In some embodiments, the concentration of sucrose of the fruit beverage is reduced, compared with the feed juice, by about 20% to about 90%, or by about 30% to about 80%, or by about 40% to about 70%, or by about 50% to about 60%. In some embodiments, the concentration of glucose of the fruit beverage is reduced, compared with the feed juice, by about 20% to about 90%, or by about 30% to about 80%, or by about 40% to about 70%, or by about 50% to about 60%. In some embodiments, the concentration of fructose of the fruit beverage is reduced, compared with the feed juice, by about 20% to about 90%, or by about 30% to about 80%, or by about 40% to about 70%, or by about 50% to about 60%.

In some embodiments, the Vitamin C concentration of the fruit beverage as described herein is increased, compared with the feed juice, by about 1% to about 100%, or from about 10% to about 90%, or from about 20% to about 80%, or from about 30% to about 70%, or from about 40% to about 60%, or from about 45% to about 55%.

In some embodiments, the limonin concentration of the fruit beverage as described herein is reduced, compared with the feed juice, by at least about 7% or at least about 10% or at least about 20% or at least about 30% or at least about 40% or at least about 50% or at least about 60% or at least about 70% or at least about 80% or at least about 90% or at least about 99%.

In some embodiment, the fruit beverage as described herein has a Brix value in a range from about 2° to about 10°, or from about 3° to about 9°, or from about 4° to about 8°, or from about 5° to about 8°, or from about 6° to about 8°, or from about 6.5° to about 7.5, or from about 6.8° to about 7.2°. In some embodiments, the fruit beverage has a Brix value that is ≤about 12°, ≤about 10°, ≤about 8°, ≤about 6°, or ≤about 4°.

In some embodiments, the fruit beverage as described herein contains sucrose, glucose, and fructose, with a concentration of total sugars in a range from about 2 g/100 g to about 8 g/100 g, or from about 3 g/100 g to about 7 g/100 g, or from about 4 g/100 g to about 6 g/100 g, or from about 4.5 g/100 g to about 5.5 g/100 g. In some embodiments, the fruit beverage has a total sugars concentration that ≤about 10 g/100 g, ≤about 8 g/100 g, ≤about 6 g/100 g, ≤about 4 g/100 g, or ≤about 2 g/100 g.

In some embodiments, the fruit beverage as described herein has a concentration of sucrose in a range from 0.5 g/100 g to about 5 g/100 g, or from about 1 g/100 g to about 4 g/100 g, or from about 1.5 g/100 g to about 3 g/100 g, or from about 1.8 g/100 g to about 2.5 g/100 g, or from about 1.8 g/100 g to about 2.2 g/100 g. In some embodiments, the fruit beverage has a sucrose concentration that is ≤about 5 g/100 g, ≤about 4 g/100 g, ≤about 3 g/100 g, ≤about 2 g/100 g, or ≤about 1 g/100 g.

In some embodiments, the fruit beverage as described herein has a concentration of glucose in a range from 0.5 g/100 g to about 4 g/100 g, or from about 1 g/100 g to about 3 g/100 g, or from about 1 g/100 g to about 2 g/100 g, or from about 1.2 g/100 g to about 1.6 g/100 g. In some embodiments, the fruit beverage has a glucose concentration that is ≤about 5 g/100 g, ≤about 4 g/100 g, ≤about 3 g/100 g, ≤about 2 g/100 g, or ≤about 1 g/100 g.

In some embodiments, the fruit beverage as described herein has a concentration of fructose in a range from 0.5 g/100 g to about 4 g/100 g, or from about 1 g/100 g to about 3 g/100 g, or from about 1 g/100 g to about 2 g/100 g, or from about 1.2 g/100 g to about 1.6 g/100 g. In some embodiments, the fruit beverage has a fructose concentration that is ≤about 5 g/100 g, ≤about 4 g/100 g, ≤about 3 g/100 g, ≤about 2 g/100 g, or ≤about 1 g/100 g.

In some embodiments of the fruit beverage as described herein, sucrose attributes from about 20% to about 60% of the total sugar, or from about 30% to about 50% of the total sugar, or from about 35% to about 45% of the total sugar. In some embodiments, glucose attributes from about 10% to about 50% of the total sugar, or from about 20% to about 40% of the total sugar, or from about 25% to about 35% of the total sugar. In some embodiments, fructose attributes from about 10% to about 50% of the total sugar, or from about 20% to about 40% of the total sugar, or from about 25% to about 35% of the total sugar. In some embodiment, the fruit beverage has a Vitamin C concentration in a range from about 20 mg/100 mL to about 80 mg/100 mL. In some embodiments the fruit beverage has a Vitamin C concentration that is ≥about 20 mg/100 mL or more, ≥about 30 mg/100 mL, ≥about 40 mg/100, ≥about 50 mg/100, ≥about 60 mg/100 mL, ≥about 70 mg/100 mL, or about 80 mg/100 mL.

In some embodiments, the fruit beverage as described herein has a limonoid concentration in a range from about 0 to about 4 mg/L, or from about 0.5 mg/L to about 3.5 mg/L, or from about 1 mg/L to about 3 mg/L, or from about 1.5 mg/L to about 2.5 mg/L, or from about 1.7 mg/L to about 2.2 mg/L.

In some embodiments, the fruit beverage as described herein derived from at least one fruit source includes Vitamin C at a concentration of at least about 35 mg/100 mL and less than 100 mg/100 mL; one of more natural sugars including sucrose, glucose, fructose, or the combinations thereof, wherein the total sugars concentration is of at most about 10 g/100 g; and a limonoid, wherein the concentration of limonoid is in a range from about 0.5 mg/100 mL to about 4 mg/100 mL, and wherein the fruit beverage has a 100% identity to the least one fruit source and is substantially free of external ingredient.

In some embodiments, the fruit beverage as described herein consists essentially of a second permeate, wherein the second permeate is produced by passing a first permeate through a second separation unit, wherein the first permeate is generated by passing a feed juice of a first fruit through a first separation unit, and the fruit beverage comprises: one or more natural sugars including sucrose, glucose, fructose, or combinations thereof, wherein the total sugars concentration is of at most about 10 g/100 g; and Vitamin C, wherein the Vitamin C concentration is in a range from about 15 mg/100 mL to about 38 mg/100 mL; and a limonoid, wherein the concentration of limonoid is less than about 0.5 mg/100 mL, and wherein the fruit beverage has a 100% identity to the feed juice and is substantially free of external ingredient. In some embodiments, the fruit beverage further comprises a portion of a second fruit source and/or a portion of feed juice.

In some embodiments, the fruit beverage is made by a fruit juice filtration process, comprising: a portion of a first retentate, wherein the first retentate is produced by passing a feed juice of a first fruit through a first separation unit, whereby a first permeate is also produced; and a portion of a second permeate, wherein the second permeate is produced by passing the first permeate of through a second separation unit, whereby a second retentate is also produced, and wherein the fruit beverage comprises: fruit solids; one or more natural sugars including sucrose, glucose, fructose, or combinations thereof, wherein the total sugars concentration is of at most about 10 g/100 g; and Vitamin C, wherein the Vitamin C concentration is of at least about 35 mg/100 mL and no more than 100 mg/100 mL, and a limonoid, wherein the concentration of limonoid is in a range from about 0.5 mg/L to about 3 mg/L, wherein the fruit beverage is substantially free of external ingredient. In some embodiments, the fruit beverage further comprises a portion of a second fruit source and/or a portion of feed juice.

### EXAMPLES

Certain embodiments of the present disclosure are further described with reference to the following examples. These examples are intended to be merely, illustrative of the disclosure and are not intended to limit or restrict the scope of the present disclosure in any way and should not be construed as providing conditions, parameters, reagents, or starting materials that must be utilized exclusively in order to practice the art of the present disclosure. The analysis of the fruit beverage was.

performed using the following analytical and quantitative equipment, such as Brix is measured by refractometer, Sugar analysis is done by HPLC-RI, Vitamin C analysis is done by HPLC and Limonin analysis is done by ESI-LC-MS. However, one of ordinary skill in the art would understand that the analysis of the various contents could be performed by other analytical means.

### Example 1—Fruit Beverage

Example 1 fruit beverage was produced by the following steps: (1) Submit a NFC orange juice to a micro-filtration process; (2) Suspended solids are retained by, a micro-filter (filtration 1 retentate); (3) Clarified orange juice passes through the micro-filter (filtration 1 permeate); (4) Submit filtration 1 permeate to a nano-filtration process; (5) Sugars are retained by the nano-filter (filtration 2 retentate); (6) Low sugar water passes through the nano-filter (filtration 2 permeate); (7) Blend filtration 1 retentate with filtration 2 permeate; (8) Add orange pulp; (9) Add acerola puree; (10) Add monk fruit juice The resulting fruit beverage was analyzed, and the characteristics are shown in Table 2.

TABLE 2
Analytical results of Example 1.

| | | | | Nano-filter | | | |
|---|---|---|---|---|---|---|---|
| | Micro-filter | | | Permeate | | Example 1 | Reduction |
| | Batch | Permeate | Retentate | 3.3x | Retentate | 40% Reduced | Example 1 |
| | (NFC) | 3.3x | 3.3x | (Calculated) | 3.3x | Calorie | Batch |
| ° Brix | 11.32 | 10.80 | 11.94 | 4.08 | 26.38 | 7.02 | −38% |
| Vitamin C (mg/100 mL) | 30.9 | 27.8 | 31.0 | 20.7 | 37.5 | 39.9 | +29% |
| Total Sugars (g/100 g) | 8.3 | 8.4 | 8.3 | 3.6 | 20.7 | 4.9 | −41% |
| Sucrose (g/100 g) | 4.1 | 4.2 | 4.1 | 0.8 | 14.2 | 1.8 | −56% |
| Glucose (g/100 g) | 1.9 | 1.9 | 1.9 | 1.4 | 4.5 | 1.4 | −26% |
| Fructose (g/100 g) | 2.3 | 2.3 | 2.3 | 1.4 | 5.4 | 1.7 | −26% |
| Limonin (mg/L) | 4.2 | 3.5 | 4.9 | 0.2 | 8.9 | 1.8 | −57% |

### Example 2—fruit beverage:

Example 2 fruit beverage was prepared according to the same procedure provided in Example 1. The resulting fruit beverage was analyzed, and the characteristics are shown in Table 3.

TABLE 3
Analytical results of Example 2.

| | | | | Nano-filter | | | |
|---|---|---|---|---|---|---|---|
| | Micro-filter | | | Permeate | | Example 2 | Reduction |
| | Batch | Permeate | Retentate | 3.3x | Batch | Permeate | Example 2 |
| | (NFC) | 3.3x | 3.3x | (Calculated) | (NFC) | 3.3x | Batch |
| ° Brix | 10.84 | 10.2 | 11.72 | 2.51 | 24.89 | 7.02 | −35% |
| Vitamin C (mg/100 mL) | 42.7 | 44.2 | 44.0 | 35.8 | 61.1 | 51.1 | +20% |
| Total Sugars (g/100 g) | 8.2 | 7.5 | 7.9 | 1.2 | 21.7 | 5.0 | −39% |
| Sucrose (g/100 g) | 4.0 | 3.9 | 3.9 | n.d.* | 12.1 | 2.1 | −48% |
| Glucose (g/100 g) | 2.1 | 1.6 | 2.0 | 0.5 | 4.8 | 1.4 | −33% |
| Fructose (g/100 g) | 2.1 | 2.0 | 2.0 | 0.7 | 4.8 | 1.5 | −29% |
| Limonin (mg/L) | 3.0 | 1.0 | 3.4 | n.d.* | 2.9 | 1.7 | −43% |

*n.d. means the content is not determined because it is below the detection limit.

The above specification, examples and data provide a complete description of the manufacture and use of the composition of the disclosure. Since many embodiments of the disclosure can be made without departing from the spirit and scope of the disclosure, the disclosure resides in the claims hereinafter appended.

1. A method of making a fruit beverage comprising:
passing a feed juice of a first fruit having a first limonoid concentration through a first separation unit comprising at least one microfilter, whereby generating a first retentate and a first permeate;
passing the first permeate through a second separation unit comprising at least one nanofilter, whereby generating a second retentate and a second permeate; and
combining a portion of one or more components selected from the group consisting of the feed juice of the first fruit, the first retentate, the second permeate, or the combinations thereof, whereby generating the fruit beverage,
wherein the fruit beverage comprises:
one or more natural sugars including sucrose, glucose, fructose; Vitamin C; and
a limonoid, wherein the limonoid concentration is reduced by at least 7% compared to the feed juice,
wherein the Vitamin C, the sugar, and the limonoid are all originated from the feed juice of the first fruit; wherein the fruit beverage is substantially free of external ingredients.

2. The method of claim 1 further comprising adding a portion of a second fruit source derived from a second fruit during the combining step, whereby generating the fruit beverage comprising the second fruit source.

3. The method of claim 2, wherein the second fruit is selected from a group consisting of citrus, acerola, monk fruit, and combinations thereof.

4. The method of claim 2, wherein the second fruit source comprises a natural part of a second fruit, including but not limited to juice, pulp, or puree, solids, a suspended solution, or combinations thereof.

5. The method of claim 1, wherein the fruit beverage has a Brix value reduced by about 20% to about 90%, or by about 30% to about 80%, or by about 40% to about 70%, or by about 50% to about 60%, compared with the feed juice.

6. The method of claim 1, wherein the fruit beverage has a total sugars concentration reduced by about 20% to about 90%, or by about 30% to about 80%, or by about 40% to about 70%, or by about 50% to about 60%, compared with the feed juice.

7. The method of claim 1, wherein the fruit beverage has a sucrose concentration reduced by about 20% to about 90%, or by about 30% to about 80%, or by about 40% to about 70%, or by about 50% to about 60%, compared with the feed juice.

8. The method of claim 1, wherein the fruit beverage has a glucose concentration reduced by about 20% to about 90%, or by about 30% to about 80%, or by about 40% to about 70%, or by about 50% to about 60%, compared with the feed juice.

9. The method of claim 1, wherein the fruit beverage has a fructose concentration reduced by about 20% to about 90%, or by about 30% to about 80%, or by about 40% to about 70%, or by about 50% to about 60%, compared with the feed juice.

10. The method of claim 1, wherein the fruit beverage has a Vitamin C concentration increased by about 1% to about 100%, or from about 10% to about 90%, or from about 20% to about 80%, or from about 30% to about 70%, or from about 40% to about 60%, or from about 45% to about 55%, compared with the first juice of the first fruit.

11. The method of claim 1, wherein the fruit beverage has a second limonoid concentration, wherein the second limonoid concentration is reduced by at least about 10% or at least about 20% or at least about 30% or at least about 40% or at least about 50% or at least about 60% or at least about 70% or at least about 80% or at least about 90% or at least about 99%, compared with the first limonoid concentration of the feed juice.

12. The method of claim 1, wherein the first retentate comprises suspended fruit solids from the first fruit.

13. The method of claim 1, wherein the first separation unit comprises at least one micro-filter having an averaged pore size in a range from 0.1 to 0.3 micrometer.

14. The method of claim 1, wherein the second separation unit comprises at least one nano-filter having an averaged molecular weight cut-off (MWCO) in a range from about 250 Da to about 800 Da.

15. The method of claim 1, wherein the juice is an NFC orange juice, and wherein the method further comprises adding to the fruit beverage a portion of a second fruit source comprising orange pulp, NFC acerola puree, and monk fruit juice, whereby forming the fruit beverage,
wherein the fruit beverage comprises:
one or more natural sugars including sucrose, glucose, fructose; wherein the total sugars concentration is reduced by at least 30% compared with the feed juice;
Vitamin C, wherein the concentration of Vitamin C is increased by at least about 20% compared with the feed juice; and
wherein the further fruit beverage has a 100% identity to the feed juice and the second fruit source; wherein the further fruit beverage is substantially free of external ingredient.

16. A fruit juice filtration system comprising:
a first separation unit for filtering a feed juice of a first fruit to produce a first retentate and a first permeate, wherein the first separation unit comprises at least one microfilter; and
a second separation unit for filtering the first retentate to produce a second retentate and a second permeate, wherein the second separation unit comprises at least one nanofilter,
wherein the second separation unit is configured to cause the second permeate to have a Brix value that is reduced by at least about 20%, compared with the feed juice.

17. A fruit juice filtration system comprising:
a first separation unit for filtering a juice of at least one fruit to produce a first retentate and a first permeate, wherein the first separation unit comprises at least one microfilter;
a second separation unit for filtering the first retentate to produce a second retentate and a second permeate, wherein the second separation unit comprises at least one nanofilter having an averaged molecular weight cut-off (MWCO) in a range from about 250 Da to about 800 Da; and
an operative unit for combining a portion of one or more components selected from the group consisting of: the feed juice, the first retentate, the second permeate, a second fruit source, or the combinations thereof, whereby generating a fruit beverage.
wherein the fruit beverage comprises:
one or more natural sugars including sucrose, glucose, fructose, or combinations thereof;
Vitamin C; and
a limonoid,
wherein the fruit beverage has a 100% identity to the feed juice and the second fruit source; wherein the fruit beverage is substantially free of external ingredient.

18. A fruit beverage derived from at least one fruit source, comprising:
Vitamin C, wherein the Vitamin C concentration is of at least about 35 mg/100 mL;
one of more natural sugars including sucrose, glucose, fructose, or the combinations thereof, wherein the total sugars concentration is of at most about 10 g/100 g; and
a limonoid, wherein the concentration of limonoid is in a range from about 0.5 mg/L to about 3 mg/L,
wherein the fruit beverage has a 100% identity to the least one fruit source; wherein the fruit beverage is substantially free of external ingredient.

19. The fruit beverage of claim 18 further comprising fruit solids, wherein the fruit solids are derived from the at least one fruit source.

20. A fruit beverage made by a fruit juice filtration process, comprising:
a portion of a first retentate, wherein the first retentate is produced by passing a feed juice of a first fruit through a first separation unit, whereby a first permeate is also produced;
a portion of a second permeate, wherein the second permeate is produced by passing the first permeate of through a second separation unit, whereby a second retentate is also produced;
a portion of a second fruit source, wherein the second fruit source is selected from a group consisting of citrus, acerola, monk fruit, and combinations thereof, and
wherein the fruit beverage comprises:
fruit solids;
one or more natural sugars including sucrose, glucose, fructose, or combinations thereof, wherein the total sugars concentration is of at most about 10 g/100 g; and
Vitamin C, wherein the Vitamin C concentration is of at least about 35 mg/100 mL; and
a limonoid, wherein the concentration of limonoid is in a range from about 0.5 mg/L to about 3 mg/L,
wherein the fruit beverage has a 100% identity to the feed juice; wherein the fruit beverage is substantially free of external ingredient.
